(19) United States
(12) Patent Application Publication
(10) Pub. No.: US 2014/0231274 A1
(43) Pub. Date: Aug. 21, 2014

(54) SINGLE MOLECULE DETECTION METHOD AND SINGLE MOLECULE DETECTION APPARATUS FOR BIOLOGICAL MOLECULE, AND DISEASE MARKER TESTING APPARATUS

(71) Applicant: PANASONIC CORPORATION, Osaka (JP)

(72) Inventors: Akio Oki, Kyoto (JP); Hiroaki Oka, Osaka (JP); Ken Shimono, Osaka (JP)

(73) Assignee: PANASONIC CORPORATION, Osaka (JP)

(21) Appl. No.: 14/347,935

(22) PCT Filed: Nov. 16, 2012
(86) PCT No.: PCT/JP2012/007367

§ 371 Date: Mar. 27, 2014

(30) Foreign Application Priority Data
Nov. 22, 2011 (JP) 2011-254561

(51) Int. Cl. G01N 27/327

(52) U.S. Cl. CPC G01N 27/327
USPC 205/792; 204/403.01

(57) ABSTRACT

A single-molecule detection device includes a substrate having a through-hole therein, a first chamber configured to accommodate a first electrolytic solution therein, a second chamber configured to accommodate a second electrolytic solution therein, an electrode pair provided around the through-hole, and a chimeric protein immobilized to one end of the through-hole. The chimeric protein includes a target sequence configured to allow the biomolecule to act thereon, a first protein provided at one end of the target sequence, and a second protein provided at another end of the target sequence. The chimeric protein is immobilized at the one end of the through-hole via the first protein. This device can readily detect a single biomolecule.

### TECHNICAL FIELD

The present invention relates to a device and method for detecting a single biomolecule to be used for analyzing an extremely trace amount of a biomolecule contained in a sample solution.

### BACKGROUND ART

Recently, a methodology for diagnosing a disease early by detecting a slight amount of a biomolecule that is peculiar to the disease contained in a sample collected from a biological body, for example, blood or urine, is being developed. An important elemental technique for achieving the methodology is to detect a single biomolecule. As a conventional technique for measuring a single biomolecule, an optical method, or an electrical method is employed.

As a method for optically detecting a single biomolecule, a fluorescent resonance energy transfer (FRET) is known. The FRET is a phenomenon that excitation energy of a fluorescent molecule is directly transferred to another (fluorescent) molecule by resonance of electrons. The efficiency of transferred energy changes according to a relative positional relation between these molecules.

FIGS. 18A to 18C are schematic views of a conventional single-molecule detection device utilizing the FRET.

FIG. 18A shows so-called chimeric protein 8 composed of plural kinds of proteins, donor molecule 10, and acceptor molecule 11 that are artificially conjugated. In FIG. 18A, PA-GFP is used as donor molecule 10, asCP is used as acceptor molecule 11, and CaM-M13 is used as biological-substance-binding linker 52. Chimeric protein 8 is irradiated with excitation light having a predetermined wavelength after being optically activated, and then, the optically activated fluorescent protein of donor molecule 10 emits fluorescent light. The change of the intensity of fluorescence is detected with highly-sensitive CCD camera 91.

As shown in FIG. 18B, when the concentration of a biological substance to be measured is low, the fluorescence emitted from donor molecule 10 is not influenced by a pigment protein or a weak fluorescent protein which is acceptor molecule 11.

As shown in FIG. 18C, when the concentration of the biological substance to be measured increases, biological substance 54 binds to biological substance binding linker 52 of chimeric protein 8, and the conformation of chimeric protein 8 changes. In this case, the fluorescence from donor molecule 10 is absorbed by acceptor molecule 11 by the FRET and the intensity of the fluorescence decreases.

In the FRET, a function of a protein to specifically recognize a biomolecule at high sensitivity is utilized. Therefore, the FRET is widely used as a useful method, and can quantify a low molecular biomolecule, such as ion, sugar, or lipid. The FRET can also measure activities of, e.g. a low-molecular-weight GTP binding protein, and phosphoenzyme.

On the other hand, as a method for electrically detecting a single biomolecule, a nanopore method is known. In the nanopore method, for example, a through-hole having a diameter of several nanometers formed in a silicon substrate is used. A pair of nano-electrodes are provided at positions opposite to each other with respect to the through-hole. When a DNA molecule passes through the through-hole, a tunnel current flows between the pair of nano electrodes via the DNA molecule. By detecting this tunnel current, a base sequence of the DNA can be read at a high speed.

Conventional arts related to the above techniques are described in PTLs 1 to 5 and NPLs 1 to 3.

### CITATION LIST

### Patent Literature

PLT 1: Japanese Patent Laid-Open Publication No. 2011-97930

PLT 2: Japanese Patent Laid-Open Publication No. 2007-40834

PLT 3: Japanese Patent Laid-Open Publication No. 2005-504282

PLT 4: Japanese Patent Laid-Open Publication No. 2011-211905

PLT 5: Japanese Patent Laid-Open Publication No. 2006-119140

### Non-Patent Literature

NPL 1: Biophysics 46(3) 164-168 (2006)

NPL 2: The Proceedings of the National Academy of Sciences 101(37) 13472-13477 (2004)

NPL 3: NANO LETTERS 11 279-285 (2011)

### SUMMARY

A single-molecule detection device includes a substrate having a through-hole therein, a first chamber configured to accommodate a first electrolytic solution therein, a second chamber configured to accommodate a second electrolytic solution therein, an electrode pair provided around the through-hole, and a chimeric protein immobilized to one end of the through-hole. The chimeric protein includes a target sequence configured to allow the biomolecule to act thereon, a first protein provided at one end of the target sequence, and a second protein provided at another end of the target sequence. The chimeric protein is immobilized at the one end of the through-hole via the first protein. This device can readily detect a single biomolecule.

### BRIEF DESCRIPTION OF DRAWINGS

FIG. 1 is a perspective view of a single-molecule detection device in accordance with Exemplary Embodiment 1.

FIG. 2 is a perspective view of the single-molecule detection device in accordance with the Embodiment 1.

FIG. 3 is a front view of a substrate of the single-molecule detection device in accordance with Embodiment 1.

FIG. 4A is an enlarged view of the substrate in accordance with Embodiment 1.

FIG. 4B is an enlarged view of the substrate in accordance with Embodiment 1.

FIG. 4C is an enlarged view of the substrate in accordance with Embodiment 1.

FIG. 5A is a schematic view of a chimeric protein of the single-molecule detection device in accordance with Embodiment 1.

FIG. 5B is a schematic view of a chimeric protein of the single-molecule detection device in accordance with Embodiment 1.

FIG. 5C is a schematic view of a chimeric protein of the single-molecule detection device in accordance with Embodiment 1.

FIG. 6A is a schematic view of the substrate around a through-hole in accordance with Embodiment 1.

FIG. 6B is a schematic view of the substrate around the through-hole in accordance with Embodiment 1.

FIG. 7A is a perspective view of the single-molecule detection device for illustrating a single-molecule detection method in accordance with Embodiment 1.

FIG. 7B is a perspective view of the single-molecule detection device for illustrating the single-molecule detection method in accordance with Embodiment 1.

FIG. 7C is a perspective view of the single-molecule detection device for illustrating the single-molecule detection method in accordance with Embodiment 1.

FIG. 8A is a perspective view of the single-molecule detection device for illustrating the single-molecule detection method in accordance with Embodiment 1.

FIG. 8B is a perspective view of the single-molecule detection device for illustrating the single-molecule detection method in accordance with Embodiment 1.

FIG. 9A is an enlarged view of the vicinity of the through-hole of the substrate in accordance with Embodiment 1.

FIG. 9B is an enlarged view of the vicinity of the through-hole of the substrate in accordance with Embodiment 1.

FIG. 9C is an enlarged view of the vicinity of a through-hole of the substrate in accordance with Embodiment 1.

FIG. 10 is a section view of a single-molecule detection device in accordance with Exemplary Embodiment 2.

FIG. 11 is an exploded projection view of the single-molecule detection device in accordance with Embodiment 2.

FIG. 12A is a section view of the substrate of the single-molecule detection device in accordance with Embodiment 2.

FIG. 12B is a section view of a substrate of the single-molecule detection device in accordance with Embodiment 2.

FIG. 12C is a section view of a substrate of the single-molecule detection device in accordance with Embodiment 2.

FIG. 13A is a perspective view of the single-molecule detection device for illustrating a single-molecule detection method in accordance with Embodiment 2.

FIG. 13B is a perspective view of the single-molecule detection device for illustrating the single-molecule detection method in accordance with Embodiment 2.

FIG. 13C is a perspective view of the single-molecule detection device for illustrating the single-molecule detection method in accordance with Embodiment 2.

FIG. 14A is a perspective view of the single-molecule detection device for illustrating the single-molecule detection method in accordance with Embodiment 2.

FIG. 14B is a perspective view of the single-molecule detection device for illustrating the single-molecule detection method in accordance with Embodiment 2.

FIG. 15A is a cross-sectional view of a substrate in accordance with Embodiment 2.

FIG. 15B is a cross-sectional view of a substrate in accordance with Embodiment 2.

FIG. 16 is a perspective view of a single-molecule detection device in accordance with Exemplary Embodiment 3.

FIG. 17A is a plan view of a substrate of the single-molecule detection device in accordance with Embodiment 3.

FIG. 17B is a plan view of a substrate of the single-molecule detection device in accordance with Embodiment 3.

FIG. 17C is a plan view of a substrate of the single-molecule detection device in accordance with Embodiment 3.

FIG. 17D is a plan view of a substrate of the single-molecule detection device in accordance with Embodiment 3.

FIG. 18A is a schematic view of fluorescence resonance energy transfer (FRET).

FIG. 18B is a schematic view of the FRET.

FIG. 18C is a schematic view of the FRET.

### DETAIL DESCRIPTION OF PREFERRED EMBODIMENTS

### Exemplary Embodiment 1

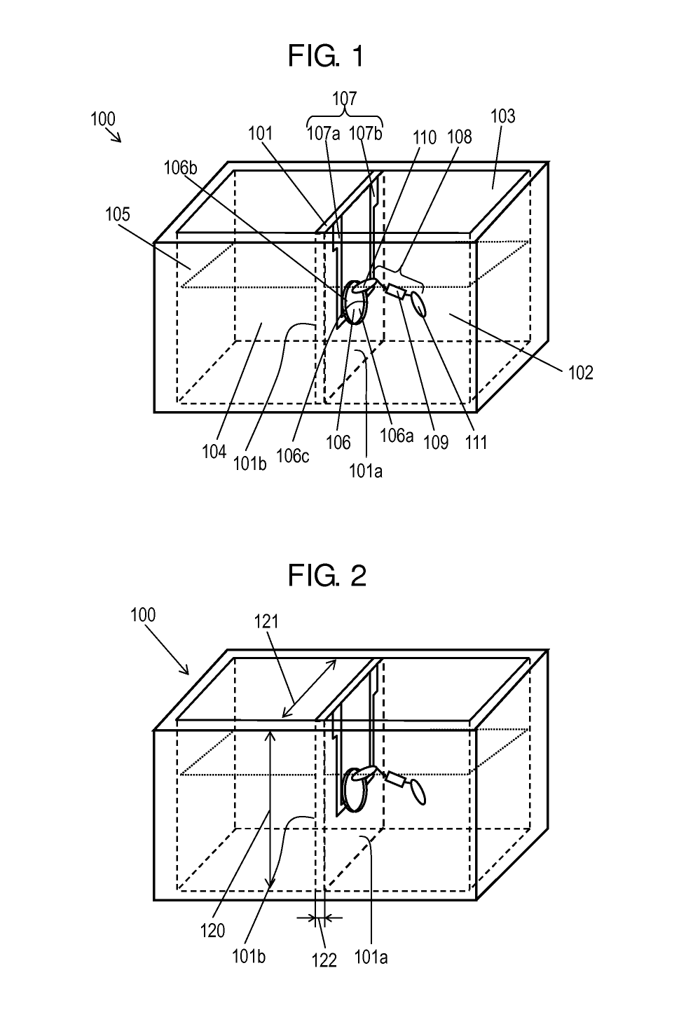

FIGS. 1 and 2 are perspective views of single-molecule detection device 100 in accordance with Exemplary Embodiment 1. Single-molecule detection device 100 includes first chamber 103, second chamber 105, and substrate 101 provided between first chamber 103 and second chamber 105. Substrate 101 has surface 101a and surface 101b opposite to surface 101a. Surface 101a faces first chamber 103 while surface 101b faces second chamber 105. First chamber 103 and second chamber 105 are configured to accommodate first electrolytic solution 102 and second electrolytic solution 104 therein, respectively.

Substrate 101 is preferably made of an inorganic material, such as an insulator, a semiconductor, or a metal. Substrate 101 may be made of an organic material. In order to electrically insulating electrolytic solution 102 accommodated in chamber 103 from electrolytic solution 104 accommodated in chamber 105, substrate 101 has a resistivity preferably not smaller than 10⁻⁵ Ωm, and more preferably not smaller than 10¹⁰ Ωm. From the viewpoint of micro-fabrication, substrate 101 is preferably made of silicon, Silicon on insulator (SOI), germanium, or ZnO.

For ease of handling, length 120 and width 121 of substrate 101 shown in FIG. 2 may range preferably from 1 mm to 10 cm. Thickness 122 of substrate 101, a distance between surfaces 101a and 101b may range preferably from 1 μm to 1 cm. Average roughness Ra of surfaces 101a and 101b of substrate 101 may be preferably not larger than 1 nm. Substrate 101 may have a rectangular shape, a circular shape, a trapezoidal shape, or a polygonal shape.

First electrolytic solution 102 is preferably an aqueous solution containing an electrolyte, and preferably contains KCl. Alternatively, first electrolytic solution 102 may contain MgCl₂, CaCl₂, BaCl₂, CsCl, CdCl₂, or NaCl. Alternatively, first electrolytic solution 102 may contain 4-(2-hydroxyethyl)-1-piperazineethanesulfonic acid (HEPES), ethylenediamine tetra acetic acid (EDTA), or ethylene glycol tetra acetic acid (EGTA). Alternatively, first electrolytic solution 102 may contain NaCl, KOH, or NaOH.

The osmotic pressure of first electrolytic solution 102 may be preferably not smaller than 10 mOsm/kg and not larger than 300 mOsm/kg. The osmotic pressure inside a cell is known to be about 300 mOsm/kg. The osmotic pressure of first electrolytic solution 102 is preferably lower than the osmotic pressure inside a cell in physiological conditions.

First electrolytic solution 102 preferably contains a water-soluble macromolecule, and for example, first electrolytic solution 102 preferably contains glucose. Alternatively, first electrolytic solution 102 preferably contains Na-GTP, Na-ATP, ATP, ADP, or GDP. From the viewpoint of suppressing evaporation of first electrolytic solution 102, the viscosity of first electrolytic solution 102 is preferably not smaller than 1.3 mPa·s and not larger than 200 mPa·s.

From the viewpoint of easily putting the solution, the amount of first electrolytic solution 102 to be put is preferably not smaller than 10 pl. From the viewpoint of retention of first electrolytic solution 102 in first chamber 103, the amount of first electrolytic solution 102 to be put is preferably not larger than 200 μl. The amount of first electrolytic solution 102 to be put is more preferably not smaller than 1 nl and not larger than 200 μl. First electrolytic solution 102 preferably stands still. First electrolytic solution 102 may flow.

From the viewpoint of easy detection of a tunnel current, the Debye length of first electrolytic solution 102 is preferably not smaller than 1 nm and not larger than 100 nm. The ion intensity of first electrolytic solution 102 is preferably not smaller than 0.001 and not larger than 1, and is more preferably not smaller than 0.01 and not larger than 0.1.

First chamber 103 faces surface 101a of substrate 101. First chamber 103 is preferably made of an inorganic material. First chamber 103 may be made of an organic material. The capacity of first chamber 103 is preferably not smaller than 10 pl and not larger than 200 μl.

Second electrolytic solution 104 preferably has the same composition as first electrolytic solution 102, but may have a composition different from that of first electrolytic solution 102.

Second electrolytic solution 104 is preferably an aqueous solution containing an electrolyte. Second electrolytic solution 104 preferably contains KCl. Second electrolytic solution 104 may contain MgCl₂, CaCl₂, BaCl₂, CsCl, CdCl₂, or NaCl. Alternatively, second electrolytic solution 104 may contain 4-(2-hydroxyethyl)-1-piperazineethanesulfonic acid (HEPES), ethylenediamine tetra acetic acid (EDTA), or ethylene glycol tetra acetic acid (EGTA). Alternatively, second electrolytic solution 104 may contain NaCl, KOH, or NaOH.

The osmotic pressure of second electrolytic solution 104 is preferably not smaller than 10 mOsm/kg and not larger than 300 mOsm/kg. The osmotic pressure inside a cell is known to be about 300 mOsm/kg. The osmotic pressure of second electrolytic solution 104 is preferably lower than the osmotic pressure inside a cell in physiological conditions.

Second electrolytic solution 104 preferably contains a water-soluble macromolecule, and preferably contains, for example, glucose. Alternatively, second electrolytic solution 104 preferably contains Na-GTP, Na-ATP, ATP, ADP, or GDP.

From the viewpoint of suppressing evaporation of second electrolytic solution 104, the viscosity of second electrolytic solution 104 is preferably not smaller than 1.3 mPa·s and not larger than 200 mPa·s.

From the viewpoint of easily putting the solution, the amount of second electrolytic solution 104 to be put is preferably not smaller than 10 pl. From the viewpoint of retaining second electrolytic solution 104 in second chamber 105, the amount of second electrolytic solution 104 to be put is preferably not larger than 200 μl. The amount of second electrolytic solution 104 to be put is more preferably not smaller than 1 nl and not larger than 200 μl. Second electrolytic solution 104 preferably stands still. Second electrolytic solution 104 may flow.

From the viewpoint of easy detection of a tunnel current, the Debye length of second electrolytic solution 104 is preferably not smaller than 1 nm and not larger than 100 nm. The ion intensity of second electrolytic solution 104 is preferably not smaller than 0.001 and not larger than 1, and is more preferably not smaller than 0.01 and not larger than 0.1.

Second chamber 105 faces surface 101b of substrate 101 opposite to surface 101a. Second chamber 105 is preferably made of an inorganic material. Second chamber 105 may be made of an organic material. The capacity of second chamber 105 is preferably not smaller than 10 pl and not larger than 200 μl.

Substrate 101 has through-hole 106 therein penetrating from surface 101a to surface 101b. Through-hole 106 has opening 106a which opens to surface 101a of substrate 101, opening 106b which opens to surface 101b of substrate 101, and inner wall surface 106c connected from opening 106a to opening 106b. Through-hole 106 preferably has a circular shape viewing from the direction perpendicular to surface 101a (101b) of substrate 101. Through-hole 106 may have an elliptical shape, a rectangular shape, a trapezoidal shape, any shape surrounded by a closed curve, or a polygonal shape viewing from the direction perpendicular to substrate 101

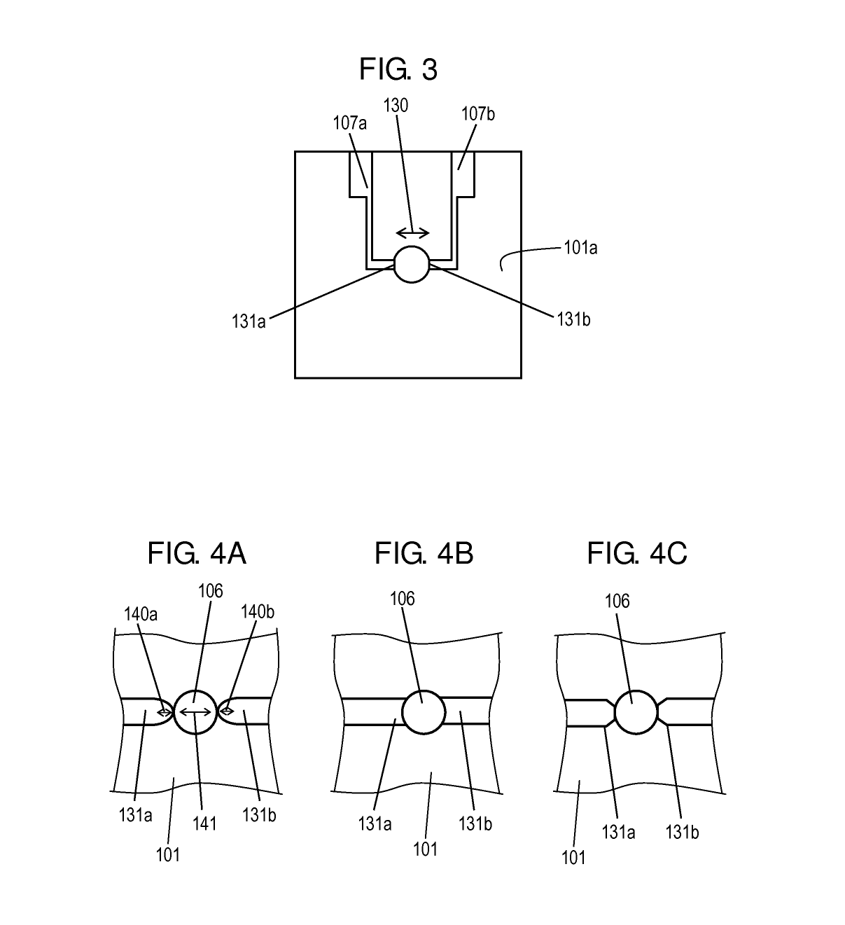

FIG. 3 is a front view of substrate 101. In the case that the shape of through-hole 106 is circular, diameter 130 of through-hole 106 is preferably not smaller than 1 nm and not larger than 100 nm, and is more preferably not smaller than 10 nm and not larger than 50 nm. The diameter of through-hole 106 is preferably larger than the diameter of a protein. The diameter of the protein in accordance with Embodiment 1 is defined as twice of hydrodynamic radius of the protein. The diameter of the protein in accordance with Embodiment 1 may be defined as twice any one of radius of inertia, radius of gyration, radius of turn, radius of volume, and van der Waals radius of the protein.

Electrode pair 107 is provided at one end of through-hole 106. Electrode pair 107 includes electrodes 107a and 107b. Electrodes 107a and 107b are preferably made of the same material. Electrodes 107a and 107b may be made of materials different from each other. From the viewpoint of detecting a tunnel current in a solution, electrodes 107a and 107b are preferably electrochemical polarized electrodes, but may be non-polarized electrodes that are not polarized electrochemically. Materials for electrodes 107a and 107b may be metal. In this case, materials of electrodes 107a and 107b are preferably noble metal, and preferably contain, for example, gold, platinum, silver, palladium, rhodium, iridium, ruthenium, or osmium. Materials for electrodes 107a and 107b are preferably not corroded by an electrolytic solution. Preferably, electrodes 107a and 107b are made of materials that do not elute into electrolytic solutions 102 and 104.

A tunnel current is detected with electrodes 107a and 107b. Electrodes 107a and 107b are configured to apply a bias voltage between electrodes 107a and 107b for detecting the tunnel current. The bias voltage is preferably not lower than 10 mV and not higher than 300 mV.

FIGS. 4A to 4C are enlarged views of substrate 101a around through-hole 106. As shown in FIG. 4A, each of tip ends 131a and 131b of electrodes 107a and 107b has a convex semi-circular shape projecting toward through-hole 106. Alternatively, as shown in FIG. 4B, each of tip ends 131a and 131b may have a concave semi-circular shape that is recessed away from through-hole 106. Alternatively, as shown in FIG. 4C, each of tip ends 131a and 131b may have a polygonal shape projecting toward through-hole 106. From the viewpoint of detecting a tunnel current, in the case that tip ends 131a and 131b of electrodes 107a and 107b is the convex semi-circular shape, curvature radii 140a and 140b of tip ends 131a and 131b are preferably not smaller than 1 nm and not larger than 100 nm. For improving the sensitivity of detecting a biomolecule by a tunnel current, the curvature radii of tip ends 131a and 131b are more preferably not smaller than 10 nm and not larger than 50 nm. The thicknesses of electrodes 107a and 107b are preferably not smaller than 1 nm and not larger than 100 nm, and more preferably, not smaller than 10 nm and not larger than 50 nm.

Tip ends 131a and 131b of electrodes 107a and 107b preferably contact opening 106a of through-hole 106. In other words, interval 141 between tip end 131a and tip end 131b is preferably identical to the diameter of opening 106a of through-hole 106. Interval 141 between tip ends 131a and 131b is preferably not smaller than 1 nm and not larger than 100 nm, and more preferably, is not smaller than 10 nm and not larger than 50 nm.

Chimeric protein 108 is immobilized around through-hole 106. According to Embodiment 1, chimeric protein 108 is immobilized at one end of through-hole 106. Chimeric protein is composed of plural different kinds of proteins that are artificially conjugated by a fusion gene created by gene recombination technology. Chimeric protein 108 is preferably a FRET indicator, such as Cameleon.

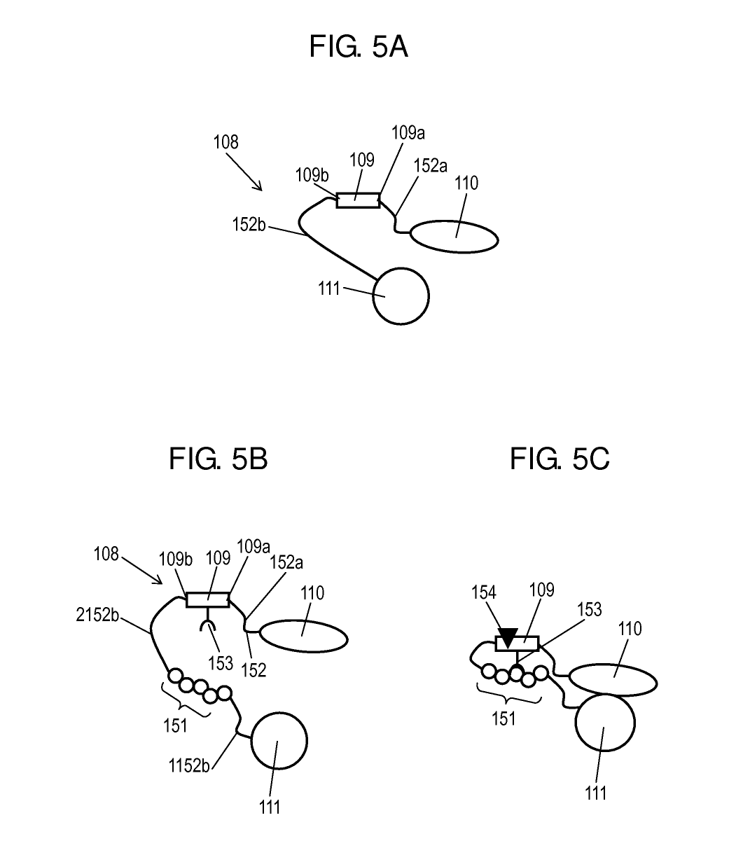

FIGS. 5A to 5C are schematic views of chimeric protein 108. As shown in FIG. 5A, chimeric protein 108 includes first protein 110, second protein 111, target sequence 109, and linker components 152a and 152b. Target sequence 109 is specifically acted on by a biomolecule. For example, target sequence 109 can bind, for example, to the biomolecule. Target sequence 109 is preferably a peptide, such as a ligand-binding peptide of calmodulin, cGMP-dependent protein kinase, a steroid hormone receptor, or a protein kinase C, to be specifically acted on by a biomolecule to bind to the biomolecule. Target sequence 109 may be a receptor, such as an inositol-1,4,5-triphosphate receptor, recoverin, an odorant receptor, or a dioxin receptor.

First protein 110 is provided at one end 109a of target sequence 109, and actually, binds to one end 109a of target sequence 109 via linker component 152a. From the viewpoint of availability, first protein 110 is preferably a fluorescent protein, such as GFP, CFP, YFP, REP, BFP or a variant thereof. First protein 110 is preferably a fibrous protein, and more preferably a globular protein. From the viewpoint of readily detecting a tunnel current, first protein 110 is preferably a metal protein. The metal protein contains a metal atom inside the protein. For suppressing denaturation of first protein 110, the pH of first electrolytic solution 102 is preferably not smaller than 2 and not larger than 11, and more preferably, is not smaller than 4 and not larger than 8. For suppressing denaturation of first protein 110, the temperature of first electrolytic solution 102 is preferably not higher than 60° C., and more preferably, is not higher than 40° C. First protein 110 preferably exhibits proton conductivity. Second protein 111 is provided at another end 109b of target sequence 109, and actually, binds to another end 109b of target sequence 109 via linker component 152b. From the viewpoint of availability, second protein 111 is preferably a fluorescent protein, such as GFP, CFP, YFP, REP, BFP or a variant thereof. Second protein 111 is preferably a fibrous protein, and more preferably a globular protein. From the viewpoint of detecting a tunnel current, second protein 111 is preferably a metal protein. The metal protein contains a metal atom inside the protein. For suppressing denaturation of second protein 111, the pH of second electrolytic solution 104 is preferably not smaller than 2 and not larger than 11, and more preferably, is not smaller than 4 and not larger than 8. For suppressing denaturation of second protein 111, the temperature of second electrolytic solution 104 is preferably not higher than 60° C., and more preferably, is not higher than 40° C. Second protein 111 preferably exhibits proton conductivity.

From the viewpoint of detecting a tunnel current, first protein 110 is more preferably CFP or a variant thereof, and second protein 111 is more preferably YFP or a variant thereof.

FIG. 5B is a schematic view of another chimeric protein 108. Chimeric protein 108 includes target peptide component 151, and includes linker components 1152b and 2152b instead of linker component 152b. Target sequence 109 includes peptide binding domain 153 binding to target peptide component 151. Linker component 2152b chemically binds target sequence 109 to target peptide component 151. Linker components 152a, 152b, 1152b, and 2152b are preferably peptide components composed of 1 to 30 of amino acid residues. Target sequence 109 and target peptide component 151 preferably bind to either first protein 110 or second protein 111. In FIG. 5B, target sequence 109 binds to first protein 110 via linker component 152a. Target sequence 109 may bind to second protein 111. In this case, target sequence 109 may bind to second protein 111 via linker component 152a. In FIG. 5B, target peptide component 151 binds to second protein 111 via linker component 1152b. Target peptide component 151 may bind to first protein 110. In this case, target peptide component 151 may bind to first protein 110 via linker component 1152b.

As shown in FIG. 5C, after biomolecule 154 acts on target sequence 109, for example, binds to target sequence 109, biomolecule 154 changes relative positions between or orientations of target peptide component 151 and peptide binding domain 153. This changes relative positions between or orientations of first protein 110 and second protein 111. For readily detecting a tunnel current, chimeric protein 108 deforms such that relative positions between or orientations of first protein 110 and second protein 111 are changed to allow first protein 110 to contact second protein 111. Even if first protein 110 and second protein 111 are apart from each other, a tunnel current may flow between first protein 110 and second protein 111. In this case, the shortest distance between first protein 110 and second protein 111 is preferably between not smaller than 0.1 nm and not larger than 1 nm.

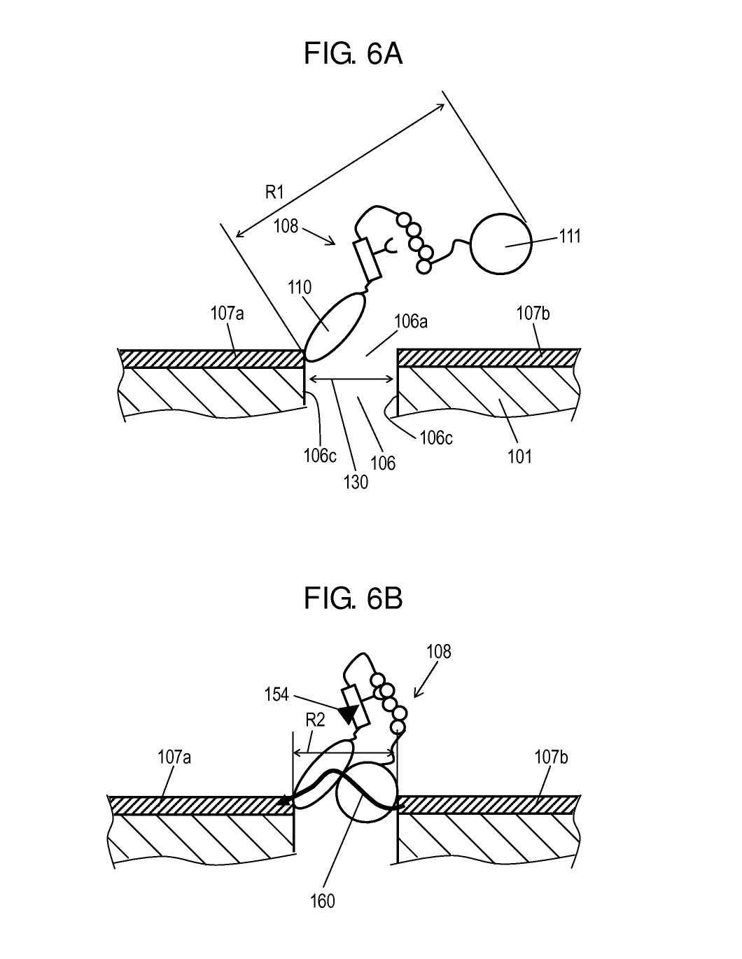

FIGS. 6A and 6B are schematic views of single-molecule detection device 100 around through-hole 106. FIG. 6A shows single-molecule detection device 100 before biomolecule 154 acts on chimeric protein 108. As shown in FIG. 6A, the interval between first protein 110 and second protein 111 is relatively large. In other words, second protein 111 is sufficiently apart from through-hole 106. FIG. 6B shows single-molecule detection device 100 after biomolecule 154 acts on chimeric protein 108. As shown in FIG. 6B, the interval between first protein 110 and second protein 111 is smaller than that shown in FIG. 6A. First protein 110 and second protein 111 electrically connect electrode 107a to electrode 107b.

The change in relative positions between or orientations of first protein 110 and second protein 111 is detected by electrode pair 107. Electrode pair 107 detects connection of electrode 107a to electrode 107b via first protein 110 and second protein 111. The change in relative positions between or orientations of first protein 110 and second protein 111 is actually detected by tunnel current 160 flowing through electrode pair 107. Second protein 111 preferably contact electrode 107a or electrode 107b. Even if second protein 111 is apart from electrode 107b, a tunnel current can flow between second protein 111 and electrode 107b. In this case, the smallest distance between second protein 111 and electrode 107b is preferably not smaller than 0.1 nm and not larger than 1 nm.

Chimeric protein 108 has diameter R1 before biomolecule 154 acts on to bind. Chimeric protein 108 has diameter R2 after biomolecule 154 acts on to bind. For improving the detection efficiency of a tunnel current, diameter 130 of through-hole 106 is preferably larger than diameter R1 of chimeric protein 108, but may not be larger than diameter R1. For improving the detection efficiency of a tunnel current, diameter 130 of through-hole 106 is preferably larger than diameter R2 of chimeric protein 108, but may be smaller than diameter R2.

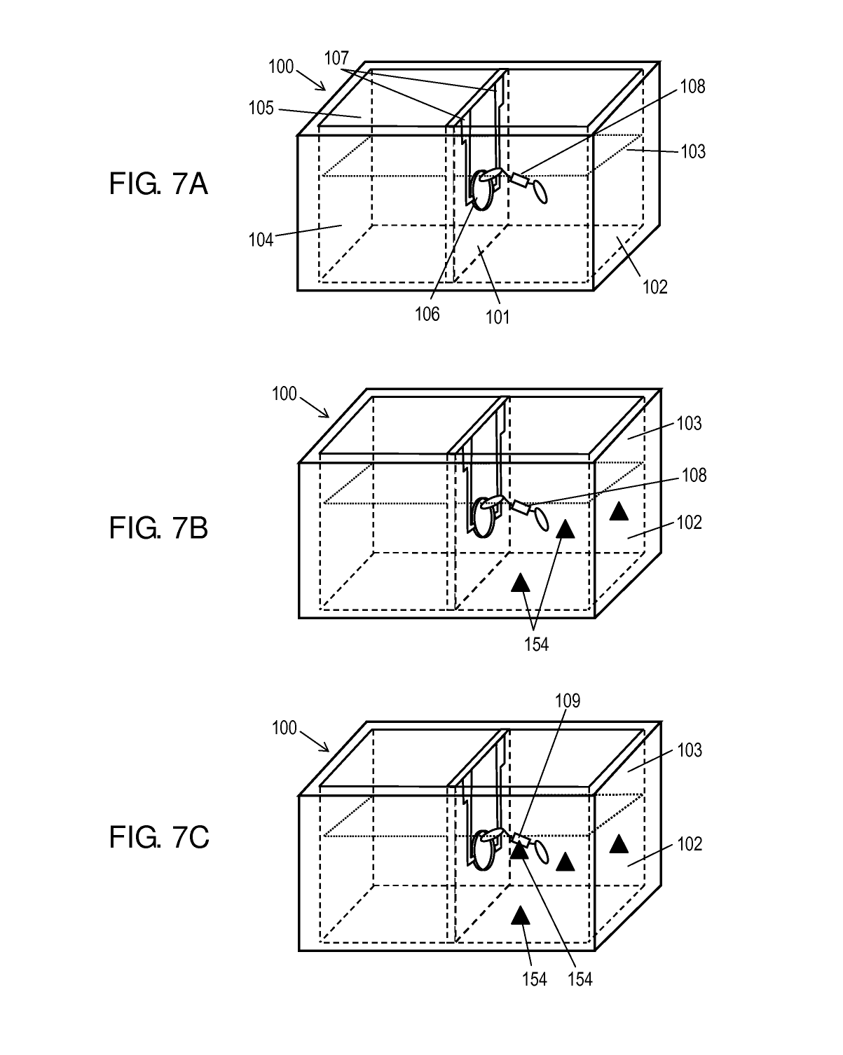

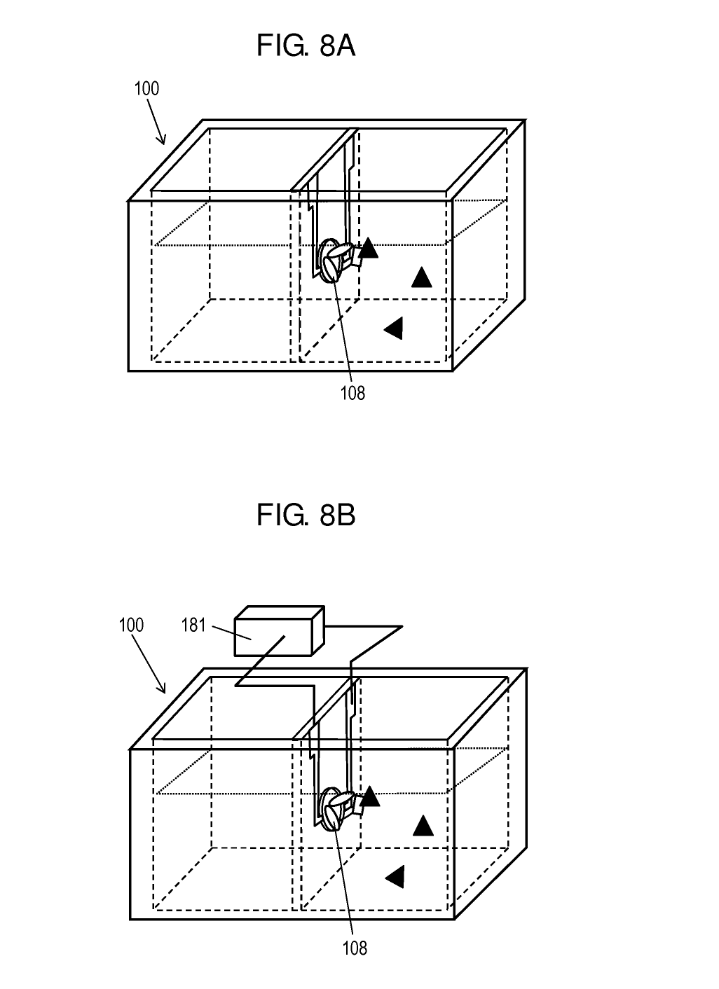

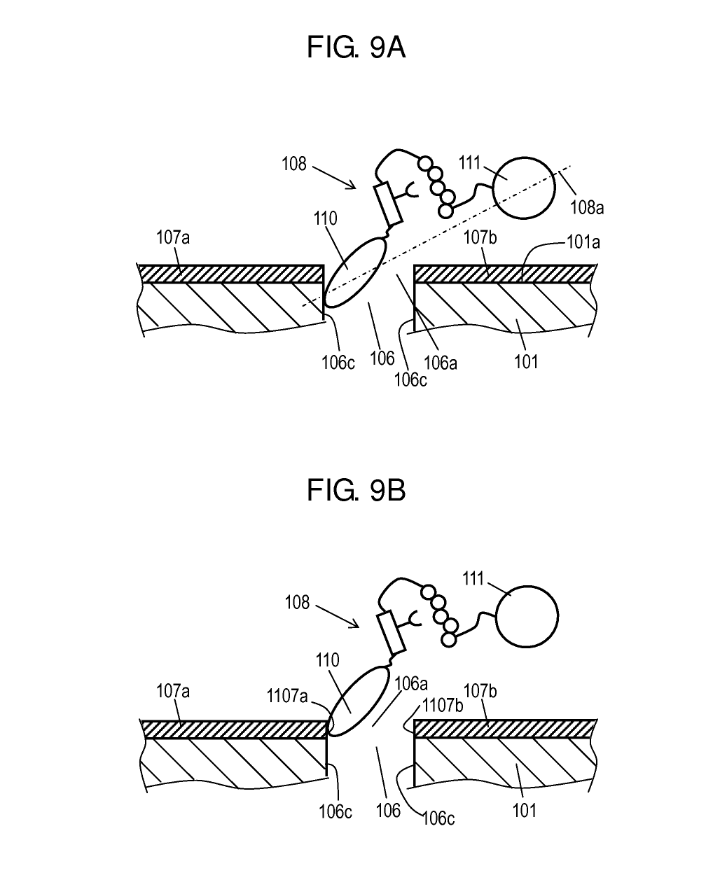

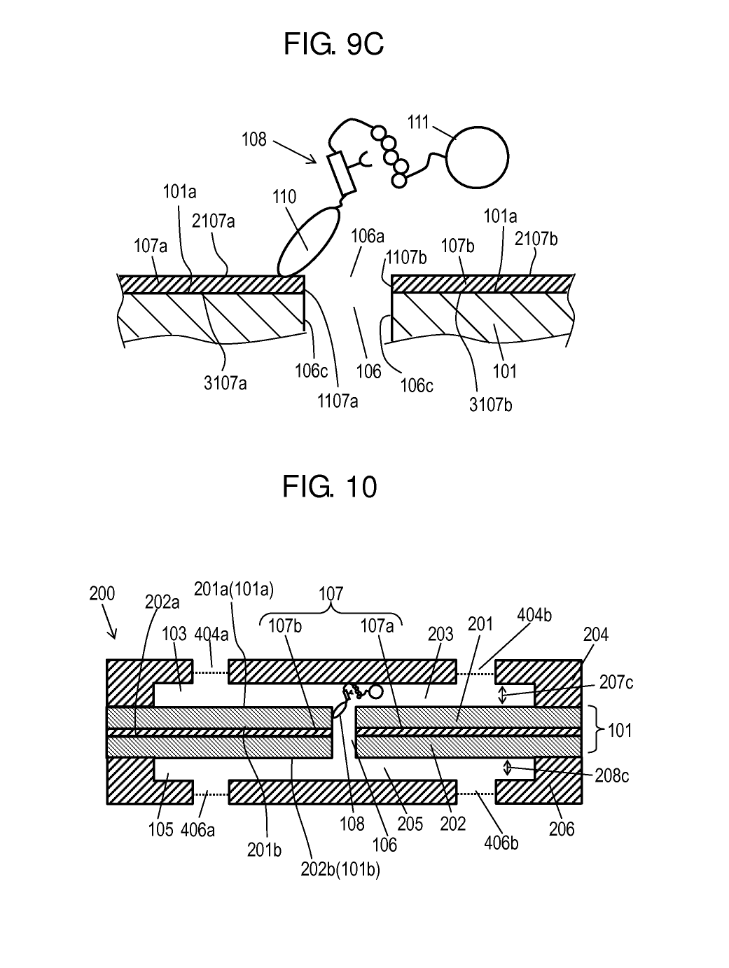

An operation of single-molecule detection device 100 will be described below. FIGS. 7A to 7C, 8A and 8B are perspective views of single-molecule detection device 100 for illustrating the operation of single-molecule detection device 100. FIGS. 9A to 9B are enlarged views of single-molecule detection device 100 around through-hole 106.

### (Process A)

In Process A, single-molecule detection device 100 shown in FIG. 7A is first prepared. Substrate 101 can be fabricated by semiconductor micro-fabrication.

First chamber 103 is preferably formed by semiconductor micro-fabrication technology, such as electron beam lithography, focused ion beam, dry etching, wet etching, ion milling, or nanoimprinting. First chamber 103 can be formed by milling or injection molding.

Second chamber 105 is preferably formed by semiconductor micro-fabrication technology, such as electron beam lithography, focused ion beam, dry etching, wet etching, ion milling, or nanoimprinting. Second chamber 105 can be formed by milling or injection molding. Second chamber 105 is formed preferably by the same method as first chamber 103, but may be formed by a different method.

Through-hole 106 is preferably formed by semiconductor micro-fabrication technology, such as electron beam lithography, focused ion beam, dry etching, wet etching, ion milling, or nanoimprinting.

Electrode pair 107 is preferably formed by semiconductor micro-fabrication technology, such as photo lithography, electron beam lithography, laser lithography, resistance heating, sputtering, electron beam vapor deposition, molecular beam epitaxy, chemical vapor deposition, electrolytic plating, or laser abrasion. Electrode pair 107 may be formed by a printing method, such as screen printing, roll printing, inkjet printing, or nanoimprinting.

For preventing leakage of first electrolytic solution 102, substrate 101 is preferably joined chemically to first chamber 103. For example, substrate 101 is joined to second chamber 105 with an adhesive. Substrate 101 may be joined to first chamber 103 by mechanical or physical means.

For preventing leakage of second electrolytic solution 104, preferably, substrate 101 is preferably joined chemically to second chamber 105. For example, substrate 101 is joined to first chamber 103 with an adhesive. Substrate 101 may be joined to second chamber 105 by mechanical or physical means.

First electrolytic solution 102 is preferably put into first chamber 103 with a pipette, but may be put with a syringe, an inkjet device, or a dispenser.

Second electrolytic solution 104 is preferably put into second chamber 105 with a pipette, but may be put with a syringe, an inkjet device, or a dispenser.

Chimeric protein 108 is preferably immobilized chemically to one end of through-hole 106, and more preferably, chimeric protein 108 is immobilized to one end of through-hole 106 by chemical bonding. As shown in FIG. 9A, first protein 110 of chimeric protein 108 is preferably located at one end of through-hole 106 and immobilized to a surface of substrate 101, i.e., to inner wall surface 106c of through-hole 106. Electrode 107a has surface 3107a disposed on surface 101a of substrate 101, surface 2107a opposite to surface 3107a, and end surface 1107a connected to surfaces 2107a and 3107a between surfaces 2107a and 3107a. Electrode 107b has surface 3107b situated on surface 101a of substrate 101, surface 2107b opposite to surface 3107b, and end surface 1107b connected to surfaces 2107b and 3107b between surfaces 2107b and 3107b. End surfaces 1107a and 1107b of electrodes 107a and 107b extend to opening 106a of through-hole 106, and face opening 106a. As shown in FIGS. 9B and 9C, first protein 110 of chimeric protein 108 is situated at one end of through-hole 106, and may be immobilized to a surface of first electrode 107a of electrode pair 107. In FIG. 9B, first protein 110 is immobilized at end surface 1107a of first electrode 107a. In FIG. 9C, first protein 110 is immobilized at surface 2107a of first electrode 107a near opening 106a of through-hole 106.

Chimeric protein 108 is preferably immobilized at through-hole 106 via one end of first protein 110. For immobilizing chimeric protein 108 at one end of through-hole 106, a binding peptide is preferably introduced to the one end of first protein 110. In this case, the binding peptide is preferably introduced to an N-terminal or a C-terminal of first protein 110. The binding peptide may be a silicon binding peptide or a biotinated peptide, and may preferably be affinity tag, histidine tag, epitope tag, HA tag, myc tag, FLAG tag, glutathione-S-transferase, or a maltose binding protein.

For immobilizing chimeric protein 108, substrate 101 which is one end of through-hole 106, and the part of electrode 107a at which first protein 110 is immobilized are preferably covered with a material having high affinity with first protein 110. In this case, the material may preferably be streptavidin, nickel, glutathione, maltose, or antibody. The material preferably covers only the surface of substrate 101, such as inner wall surface 106c of through-hole 106, and more preferably covers only inner wall surface 106c of through-hole 106. The material may cover only the surfaces of electrodes 107a and 107b of electrode pair 107. The material may cover only the electrode out of electrodes 107a and 107b of electrode pair 107 at which first protein 110 is immobilized.

As shown in FIG. 9A, before a biomolecule acts, chimeric protein 108 is configured that first protein 110 and second protein 111 are arranged along axis 108a. For immobilizing chimeric protein 108 while maintaining axis 108a of chimeric protein 108 at a predetermined angle with respect to substrate 101, one end of through-hole 106 is preferably covered with a self-assembled monolayer (SAM). In this case, the SAM preferably includes a carboxyl group or an amino group at terminals thereof.

From the viewpoint of improving the operation efficiency, chimeric protein 108 is preferably immobilized to one end of through-hole 106 before putting first electrolytic solution 102 into first chamber 103. However, chimeric protein 108 may be immobilized to one end of through-hole 106 after first electrolytic solution 102 is put into first chamber 103. Alternatively, chimeric protein 108 may be immobilized to one end of through-hole 106 simultaneously to putting first electrolytic solution 102 into first chamber 103.

### (Process B)

In Process B, as shown in FIG. 7B, a sample solution containing biomolecule 154 is introduced into first chamber 103.

Biomolecule 154 is a component contained in a sample, such as blood, lymph, spinal fluid, urine, saliva, body fluid, sweat, tear, expiration, or tissue exudate, collected from a biological body. Biomolecule 154 may be a component contained in a sample collected from animal, plant, cell, tissue, or organ. Biomolecule 154 may be a component contained in bacterium, virus, fungus, or parasite.

The sample solution containing biomolecule 154 is preferably subjected to a pretreatment. In the pretreatment, for example, a substance that interferes with detection may be removed from the sample solution containing biomolecule 154. For suppressing clogging of through-hole 106, in the pretreatment, a substance having a larger size than through-hole 106 may be removed from the sample solution containing biomolecule 154.

The sample solution containing biomolecule 154 is preferably put into first chamber 103 with a pipette, but may be put into first chamber 103 with a syringe, an inkjet device, or a dispenser.

### (Process C)

In Process C, as shown in FIG. 7C, biomolecule 154 acts on target sequence 109, e.g. binds to target sequence 109 according to Embodiment 1.

Biomolecule 154 can reach target sequence 109 by diffusion. Biomolecule 154 may reach target sequence 109 by convection. For allowing biomolecule 154 to reach target sequence 109 sufficient times, first electrolytic solution 102 is preferably stirred. The temperature of first electrolytic solution 102 may be controlled by a heater. First electrolytic solution 102 preferably flows.

Biomolecule 154 preferably binds to or acts on target sequence 109 by a hydrogen bond, van der Waals force, electrostatic force, or a covalent bond.

### (Process D)

In Process D, as shown in FIG. 8A, the acting of biomolecule 154 in Process C causes a change in the conformation of chimeric protein 108, and thus, causes chimeric protein 108 to deform.

As a result of the change in the conformation and the deformation of chimeric protein 108, the relative distance between first protein 110 and second protein 111 changes. At this moment, for example, the relative distance between second protein 111 and first protein 110 preferably decreases. Alternatively, the relative distance between second protein 111 and first protein 110 may increase. Alternatively, the orientation of second protein 111 relative to first protein 110, namely, the angle of axis 108a relative to substrate 101 may change.

Second protein 111 preferably contacts first protein 110 and/or through-hole 106. Second protein 111 preferably contact first protein 110 and/or electrode 107b of electrode pair 107. Second protein 111 may contact first protein 110 and/or electrode 107a.

### (Process E)

In Process E, as shown in FIG. 8B, the change in the conformation, namely, the deformation of chimeric protein 108 is detected as a change in tunnel current 160 flowing in electrode pair 107 (FIG. 6B).

The tunnel current flowing in electrode pair 107 is detected by tunnel current detector 181. Since the tunnel current to be detected is very small, tunnel current detector 181 preferably includes a current-voltage converter circuit, a stray capacitance, an operational amplifier, an absolute value circuit, a target tunnel current subtracting circuit, and a lock-in amplifier. Tunnel current detector 181 may preferably employ a patch-clamp amplifier. Tunnel current detector 181 detects at least one of the amplitude, phase, and frequency of the tunnel current.

For removing a current caused by the stray capacitance, a high-frequency bias voltage of sine wave or rectangular wave is preferably applied between electrodes 107a and 107b of electrode pair 107.

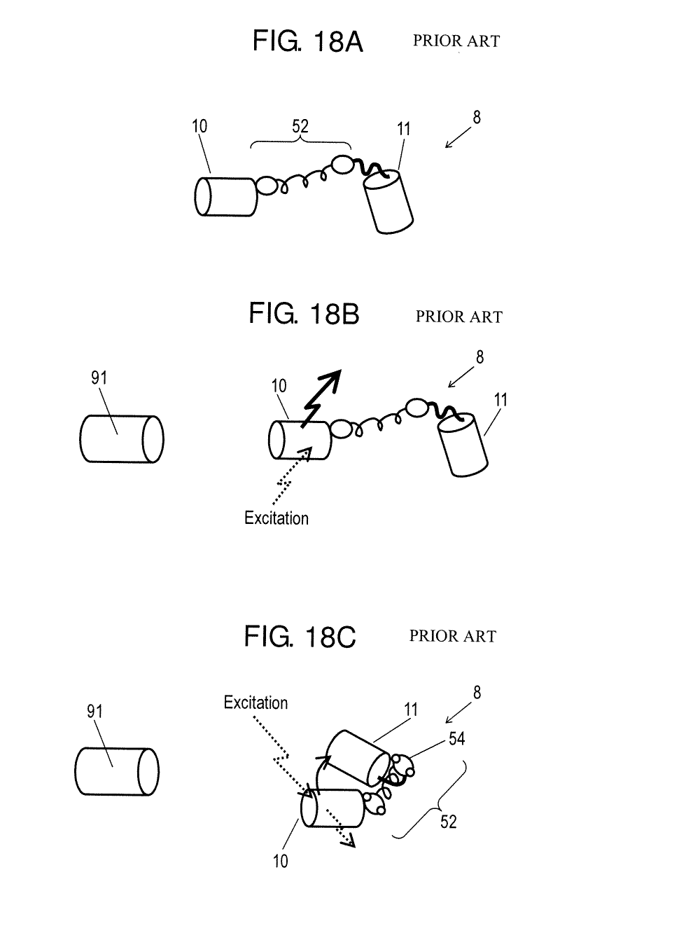

The FRET shown in FIGS. 18A to 18C can hardly detect only a single biomolecule for the following reasons in the FRET: (1) energy radiated from a single fluorescent molecule is small; (2) discoloration occurs; and (3) blinking at a time interval in the order of millisecond to second occurs.

On the other hand, in a nanopore method, a single biomolecule can be detected relatively readily only by detecting a tunnel current. However, it is very difficult to distinguish biomolecules, such as peptide, a low molecular organic compound, and amino acid, other than bases only from the change in the tunnel current.

In the single-molecule detection method using single-molecule detection device 100 according to Embodiment 1, the presence or absence of a single biomolecule is transduced into the change in the conformation of a chimeric protein rather than a method in which faint and instable fluorescence is detected from a single fluorescent molecule. Since the change in the conformation is detected as the change in the tunnel current, it is possible to readily detect the single biomolecule.

### Exemplary Embodiment 2

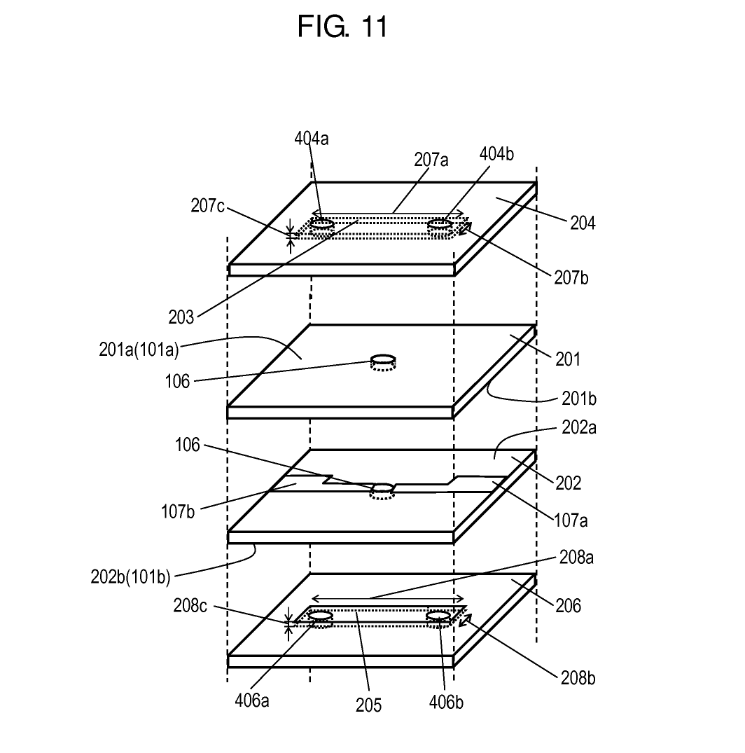

FIG. 10 and FIG. 11 are a section view and an exploded projection view of single-molecule detection device 200 in accordance with Exemplary

Embodiment 2, respectively. In FIGS. 10 and 11, components identical to those of single-molecule detection device 100 in accordance with Embodiment 1 shown in FIGS. 1 to 9C are denoted by the same reference numerals.

Single-molecule detection device 200 in accordance with Embodiment 2 includes first flow channel 203 and second flow channel 205 that are micro flow channels serving as a first chamber and a second chamber instead of first chamber 103 and second chamber 105 of single-molecule detection device 100 in accordance with Embodiment 1. These micro flow channels allow a slight amount of a sample solution to be analyzed. Further, since a lot of kinds of sample solutions can be put into single-molecule detection device 200 simultaneously, single-molecule detection device 200 can readily detect a single biomolecule.

Substrate 101 includes plural substrates that are bonded together, and includes first substrate 201 and second substrate 202 in accordance with Embodiment 2. In substrate 101, the substrates are preferably made of the same material, but may be made of different materials. First substrate 201 has surfaces 201a and 201b opposite to each other, and second substrate 202 has surfaces 202a and 202b opposite to each other. Surface 202a of second substrate 202 is bonded to surface 201b of first substrate 201. Surface 201a of first substrate 201 is first surface 101a of substrate 101 while surface 202b of second substrate 202 is second surface 101b of substrate 101. Electrodes 107a and 107b of electrode pair 107 are provided not on first surface 101a of substrate 101 but between surface 201b of first substrate 201 and surface 202a of second substrate 202. In the case that electrode pair 107 entirely covers surface 201b of first substrate 201 and surface 202a of second substrate 202, electrode pair 107 joined onto surface 201b of first substrate 201 and surface 202a of second substrate 202. Surface 201b of first substrate 201 faces surface 202a of second substrate 202 across electrode pair 107.

First substrate 201 and second substrate 202 are preferably made of insulation material, such as SiO₂, SiN, SiON, or alumina oxide.

First flow channel 203 is constituted by first substrate 201 and first cover 204. Inlet 404a for putting first electrolytic solution 102 and outlet 404b for discharging first electrolytic solution 102 which has been put are provided at both ends of first flow channel 203. A filter may be disposed in first flow channel 203. First cover 204 is preferably made of an organic material. In this case, first cover 204 is preferably made of Polydimethylsiloxane (PDMS). First cover 204 may be made of an inorganic material.

Length 207a in the direction along which inlet 404a and outlet 404b of first flow channel 203 are arranged is preferably not smaller than 100 μm and not larger than 10 mm, and more preferably, is not smaller than 500 μm and not larger than 2 mm. Width 207b of first flow channel 203 in the direction perpendicular to the direction along which inlet 404a and outlet 404b are arranged is preferably not smaller than 10 nm and not larger than 1 mm, and more preferably, is not smaller than 100 nm and not larger than 100 μm. Height 207c of first flow channel 203 from first surface 201a of substrate 201 to first cover 204 is preferably not smaller than 10 nm and not larger than 1 mm, and more preferably, is not smaller than 100 nm and not larger than 100 μm.

First flow channel 203 preferably extends straight viewed from the normal direction of first surface 201a of substrate 201, and may extend in an arbitrary curved or circular shape.

Second flow channel 205 is constituted by second substrate 202 and second cover 206. Inlet 406a for putting second electrolytic solution 104 and outlet 406b for discharging of put second electrolytic solution 104 are provided at both ends of second flow channel 205. Second cover 206 is preferably made of an organic material, such as Polydimethylsiloxane (PDMS). Second cover 206 may be made of an inorganic material.

Length 208a of second flow channel 205 in the direction along which inlet 406a and outlet 406b are arranged is preferably not smaller than 100 μm and not larger than 10 mm, and more preferably, is not smaller than 500 μm and 2 mm. Width 208b in the direction perpendicular to the direction along which inlet 406a and outlet 406b of second flow channel 205 are arranged is preferably not smaller than 10 nm and not larger than 1 mm, and more preferably, is not smaller than 100 nm and not larger than 100 μm. Height 208c of second flow channel 205 from second surface 201b of substrate 201 to second cover 206 is preferably not smaller than 10 nm and not larger than 1 mm, and more preferably, is not smaller than 100 nm and not larger than 100 μm. The dimension of first flow channel 203 and the dimension of second flow channel 205 are preferably identical to each other, but may be different from each other.

Second flow channel 205 preferably extends straight viewed from the normal direction of second surface 201b of substrate 201, and may extend in an arbitrary curved or circular shape.

For easily putting the solutions, the inner walls of first flow channel 203 and/or second flow channel 205 are preferably hydrophilized.

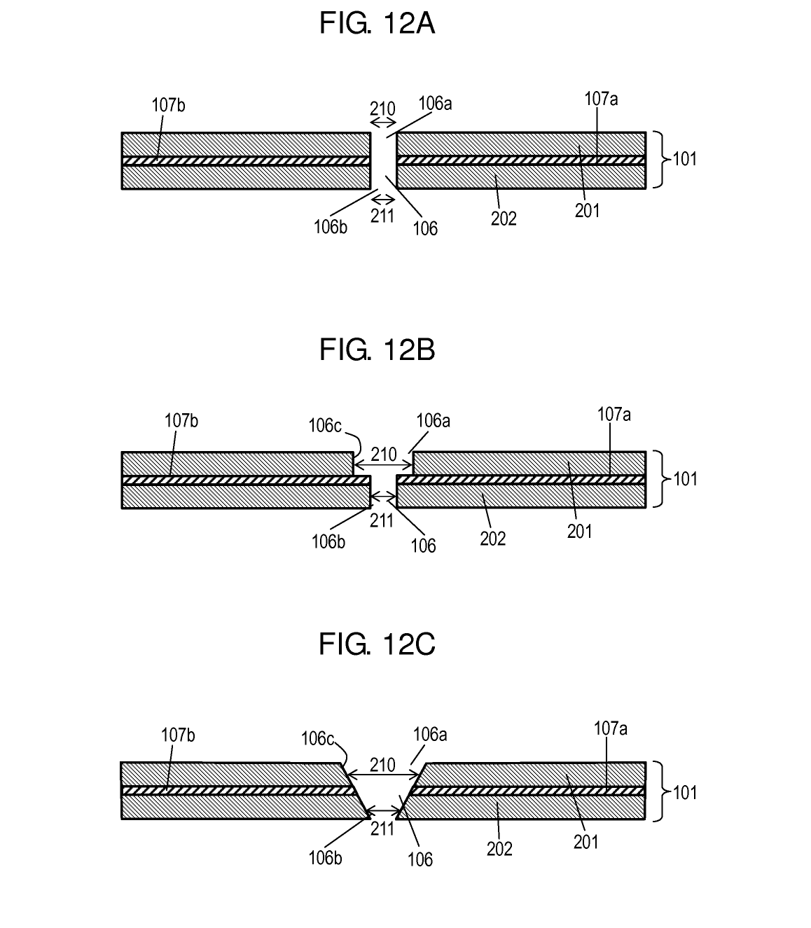

Through-hole 106 is provided in substrate 101 (first substrate 201 and second substrate 202) to penetrate through surfaces 201a and 201b of first substrate 201 and surfaces 202a and 202b of second substrate 202. FIG. 12A is a cross-sectional view of substrate 101. As shown in FIG. 12A, diameter 210 of opening 106a of through-hole 106 which opens to first substrate 201 is equal to diameter 211 of opening 106b of through-hole 106 which opens to second substrate 202.

FIG. 12B is a cross-sectional view of substrate 101 having through-hole 106 having another shape. For easy immobilization of chimeric protein 108, or for allowing easy change in the conformation, namely, deformation of chimeric protein 108, as shown in FIG. 12B, diameter 210 of opening 106a of through-hole 106 which opens to first substrate 201 is preferably larger than diameter 211 of opening 106b of through-hole 106 which opens to second substrate 202. Inner wall surface 106c of through-hole 106 has a step, and is perpendicular to first surface 201a in first substrate 201 and is perpendicular to second surface 101b in second substrate 202.

FIG. 12C is a cross-sectional view of substrate 101 having through-hole 106 therein having still another shape. For easy immobilization of chimeric protein 108, or for allowing easy change in conformation, namely deformation of chimeric protein 108, as shown in FIG. 12C, diameter 210 of opening 106a in first substrate 201 is larger than diameter 211 of opening 106b in second substrate 202. Inner wall surface 106c of through-hole 106 thus has a smooth tapered shape without a step.

In the substrate shown in FIGS. 10 to 12C, one through-hole 106 is provided in substrate 201. Plural through-holes 106 may be provided in substrate 201.

For easily putting the solution, inner wall surface 106c of through-hole 106 and surfaces 101a and 101b near inner wall surface 106c are preferably hydrophilized.

Single chimeric protein 108 is preferably immobilized at one end of through-hole 106. Plural chimeric proteins 108 may be immobilized at one end of through-hole 106. In this case, plural chimeric proteins 108 that are immobilized are preferably of the same kind, but may be of different kinds.

First protein 110 and/or second protein 111 is preferably a metal protein containing metal ion. In this case, first protein 110 and/or second protein 111 is preferably a metal protein containing ion of transition metal, such as copper, nickel, iron, zinc, chromium, manganese or cobalt. First protein 110 and/or second protein 111 may be a metal protein containing a metal complex. In this case, first protein 110 and/or second protein 111 is preferably a metal protein containing a complex of transition metal, such as copper, nickel, iron, zinc, chromium, manganese or cobalt. First protein 110 and/or second protein 111 may be an electron-donating protein. First protein 110 and/or second protein 111 may be an electron-accepting protein. First protein 110 and/or second protein 111 may be a hole-donating protein. First protein 110 and/or second protein 111 may be a hole-accepting protein. First protein 110 and/or second protein 111 may contain a donor that donates an electron in a molecule and an acceptor that accepts an electron. First protein 110 and/or second protein 111 may be doped with impurities.

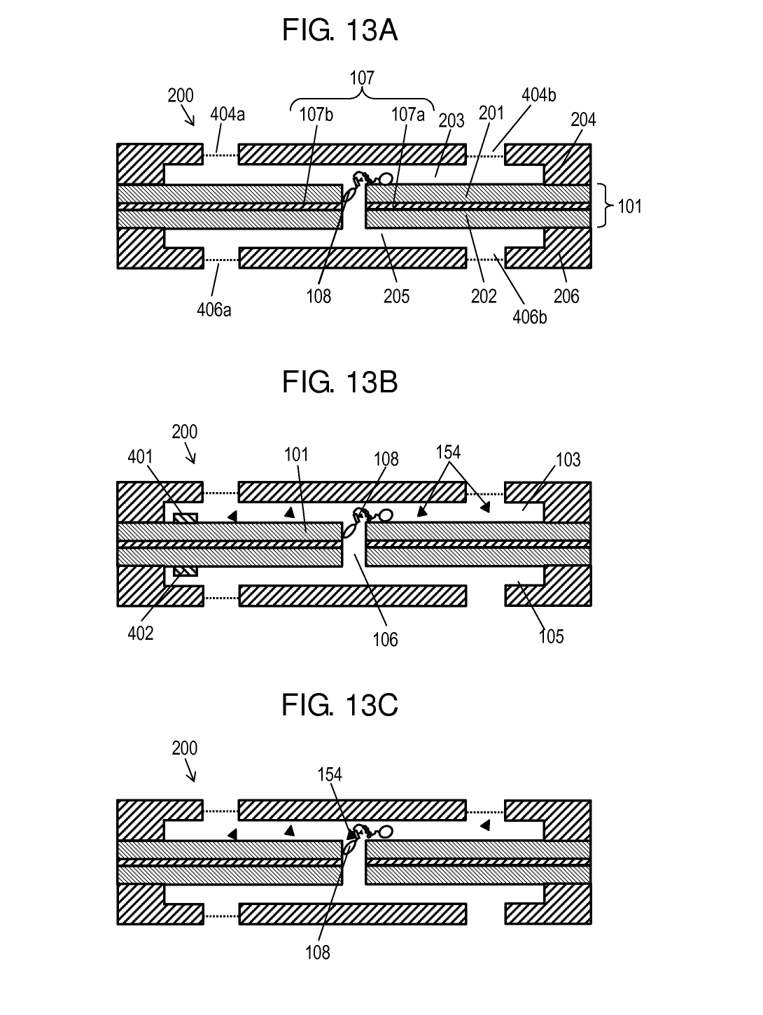

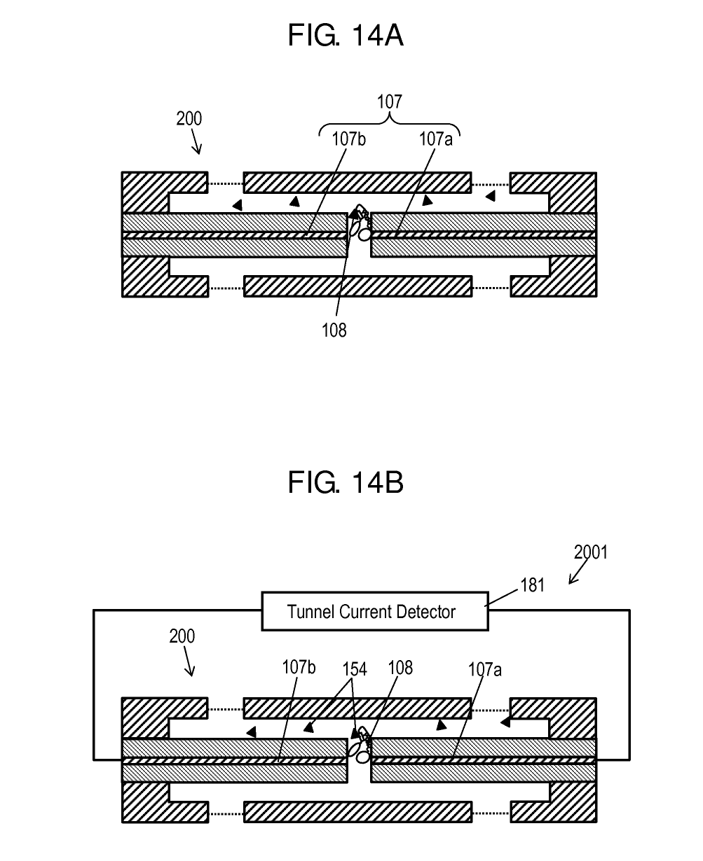

FIGS. 13A to 13C, 14A, and 14B are perspective views of single-molecule detection device 200 in accordance with Embodiment 2 for illustrating a single-molecule detection method using single-molecule detection device 200. In FIGS. 13A to 13C, 14A, and 14B, components identical to those of single-molecule detection device 100 in accordance with Embodiment 1 shown in FIGS. 7A to 7C, 8A, and 8B are denoted by the same reference numerals.

### (Process A)

In Process A, as shown in FIG. 13A, single-molecule detection device 200 is first prepared.

For suppressing deterioration of biomolecule detecting characteristics, the surface including inner wall surface 106c of through-hole 106 in first substrate 201 and/or second substrate 202 is preferably covered with an amorphous solid layer made of SiOX containing substance X. Substance X is preferably a substance having larger electronegativity than silicon, and is, for example, nitrogen, phosphorus, fluorine, or boron. The surface including inner wall surface 106c of through-hole 106 in first substrate 201 and/or second substrate 202 may be covered with a thin film of SiON. The this film of SiON can be formed by thermal nitridation of a silicon dioxide film.

First electrolytic solution 102 is put into first chamber 203 through inlet 404a to fill first chamber 203 with first electrolytic solution 102. An excessive portion of first electrolytic solution 102 is discharged through outlet 404b. Outlet 404b can remove air bubbles put in first chamber 203 through outlet 404b.

First electrolytic solution 102 is put into first chamber 203 preferably by capillary force.

From the viewpoint of allowing biomolecule 154 to reach chimeric protein 108 readily, first electrolytic solution 102 preferably flows. First electrolytic solution 102 preferably flows at a constant flow rate not smaller than 10 pl/minute and not larger than 10 ml/minute, but may flow at a flow rate changing with time. From the viewpoint of suppressing occurrence of detection noise, first electrolytic solution 102 preferably stands still.

Second electrolytic solution 104 is put into second chamber 205 through inlet 406a to fill second chamber 205 with second electrolytic solution 104. An excessive portion of second electrolytic solution 104 is discharged through outlet 406b. Outlet 406b can remove air bubbles put in second chamber 205 through outlet 406b.

Second electrolytic solution 104 is put into second chamber 205 preferably by capillary force.

For ease of detection of single biomolecule 154, first chamber 203 is not filled with first electrolytic solution 102 preferably during transportation and/or storage. First chamber 203 is preferably filled with first electrolytic solution 102 immediately before detecting of single biomolecule 154. Second chamber 205 is not filled with second electrolytic solution 104 preferably during transportation and/or storage. Second chamber 205 is preferably filled with second electrolytic solution 104 immediately before detecting of single biomolecule 154.

From the viewpoint of allowing biomolecule 154 to reach chimeric protein 108 readily, second electrolytic solution 104 preferably flows. In this case, second electrolytic solution 104 preferably flow at a constant flow rate not smaller than 10 pl/minute and not larger than 10 ml/minute, but may flow at a flow rate changing with time. The flow rate of second electrolytic solution 104 is preferably larger than the flow rate of first electrolytic solution 102. From the viewpoint of suppressing occurrence of detection noise, second electrolytic solution 104 preferably stands still.

For ease of detection of single biomolecule 154, chimeric protein 108 is not immobilized at one end of through-hole 106 preferably during transportation and/or storage. Chimeric protein 108 is preferably immobilized at one end of through-hole 106 immediately before detecting of single biomolecule 154.

### (Process B)

In Process B, as shown in FIG. 13B, a sample solution containing biomolecule 154 is introduced into first chamber 203.

The sample solution containing biomolecule 154 is preferably put into first chamber 203 by capillary force.

### (Process C)

In Process C, as shown in FIG. 13C, biomolecule 154 acts on target sequence 109, and binds to target sequence 109 in accordance with Embodiment 2.

Biomolecule 154 reaches target sequence 109 preferably by electrostatic force. Electrode 401 and electrode 402 are preferably provided at one end of first chamber 203 and one end of second chamber 205, respectively, and a voltage is applied between first electrolytic solution 102 and second electrolytic solution 104. A direct-current (DC) voltage may be applied between electrodes 401 and 402 to apply a DC voltage between first electrolytic solution 102 and second electrolytic solution 104. An alternating-current (AC) voltage may be applied between electrodes 401 and 402 to apply an AC voltage between first electrolytic solution 102 and second electrolytic solution 104. For efficiently detecting biomolecule 154, biomolecule 154 is collected preferably near through-hole 106 by a dielectrophoresis phenomenon. For collecting biomolecule 154 near through-hole 106, a hydrostatic pressure difference is preferably applied between first electrolytic solution 102 and second electrolytic solution 104. The combination of the voltage and the hydrostatic pressure difference can collect biomolecule 154 near through-hole 106 more efficiently. Biomolecule 154 may be collected near through-hole 106 by gravity.

### (Process D)

In Process D, as shown in FIG. 14A, the conformation of chimeric protein 108 changes by Process C.

### (Process E)

In Process E, as shown in FIG. 14B, the change in conformation of chimeric protein 108 is detected as a change in a tunnel current flowing in electrode pair 107. The change in the tunnel current is detected by tunnel current detector 181.

Processes A to E are preferably conducted automatically by programming.

Single biomolecule detection device 200 in accordance with Embodiment 2 includes substrate 101, first chamber 203 disposed on one end of substrate 101, and second chamber 205 disposed on another end of substrate 101. Substrate 101 is configured to be filled with first electrolytic solution 102. Second chamber 205 is configured to be filled with second electrolytic solution 104. Substrate 101 has through-hole 106 therein penetrating through both sides of substrate 101. Electrode pair 107 is disposed at one end of through-hole 106. Chimeric protein 108 is immobilized at one end of through-hole 106. Chimeric protein 108 includes target sequence 109 configured to have biomolecule 154 acting thereon, first protein 110 provided at one end of target sequence 109, and second protein 111 provided at another end of target sequence 109. Chimeric protein 108 is immobilized at one end of through-hole 106 via first protein 110.

Single-molecule detection device 200 and tunnel current detector 181 in accordance with Embodiment 2 can be used as disease marker test device 2001 that executes the procedure of Processes A to E.

Electrodes 107a and 107b of electrode pair 107 shown in FIGS. 10 and 11 are flush with surface 201b of first substrate 201 or surface 202a of second substrate 202. Electrodes 107a and 107b of electrode pair 107 may not be flush with each other.

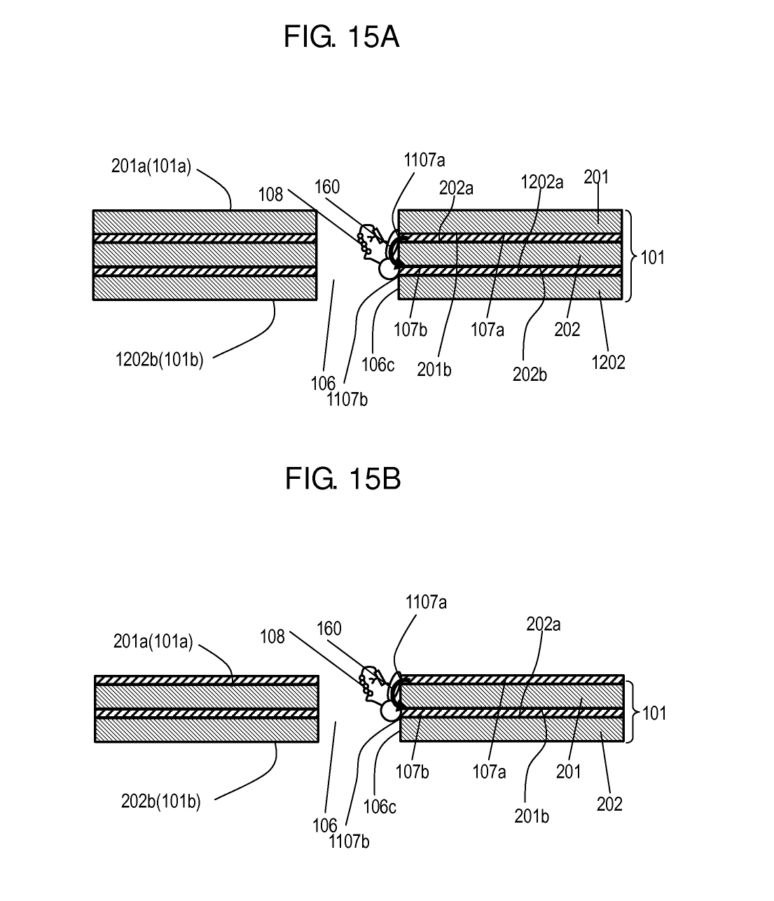

FIG. 15A is a cross-sectional view of substrate 101 having another structure in accordance with Embodiment 2. In FIG. 15A, components identical to those of substrate 101 shown in FIG. 12A are denoted by the same reference numerals. Substrate 101 shown in FIG. 15A further includes third substrate 1202 bonded to second substrate 202. Third substrate 1202 has surface 1202a bonded to surface 202b of second substrate 202, and surface 1202b opposite to surface 1202a. Surface 202b of third substrate 1202 is surface 101b of substrate 101. Electrode 107b is provided not on surface 202a of second substrate 202 and surface 201b of first substrate 201 but on surface 202b of second substrate 202 and surface 1202a of third substrate 1202. In the case that electrode 107b entirely covers surface 202b of second substrate 202 or surface 1202a of third substrate 1202, electrode 107b is joined to surface 202b of second substrate 202 and surface 1202a of third substrate 1202, and surface 202b of second substrate 202 faces surface 1202a of third substrate 1202 across electrode 107b. Electrode 107a faces electrode 107b across second substrate 202. End surface 1107a of electrode 107a and end surface 1107b of electrode 107b are exposed to inner wall surface 106c at positions between openings 106a and 106b of through-hole 106. Since electrodes 107a and 107b are provided on surfaces 202a and 202b of one substrate 202, respectively, the interval between electrodes 107a and 107b can be controlled finely. As shown in FIG. 15A, tunnel current 160 flows in the direction parallel to inner wall surface 106c of through-hole 106 of substrate 101. Tunnel current 160 may flow in a direction inclining with respect to the surface of substrate 101.

FIG. 15B is a cross-sectional view of substrate 101 having still another structure in accordance with Embodiment 2. In FIG. 15B, components identical to those of substrate 101 shown in FIG. 12A are denoted by the same reference numerals. Electrode 107b is provided on surface 202a of second substrate 202 and surface 201b of first substrate 201. Electrode 107a faces electrode 107b across first substrate 201. End surface 1107a of electrode 107a is exposed to opening 106a of through-hole 106, and end surface 1107b of electrode 107b is exposed to inner wall surface 106c at a position between openings 106a and 106b of through-hole 106. Since electrodes 107a and 107b are provided on both surfaces 201a and 201b of one substrate 201, respectively, the interval between electrodes 107a and 107b can be controlled finely. As shown in FIG. 15B, tunnel current 160 flows in a direction parallel with inner wall surface 106c of through-hole 106 of substrate 101. Tunnel current 160 may flow in a direction inclining with respect to the surface of substrate 101.

As described above, in single-molecule detection device 200 in accordance with Embodiment 2, micro flow channels used as first chamber 203 and second chamber 205 provide the following effects: (1) it is possible to analyze a slight amount of a sample solution; and (2) it is possible to readily detect a single biomolecule since many kinds of sample solutions can be put in the single-molecule detection device simultaneously.

In single biomolecule detection device 200, first chamber 203 may be previously filled with first electrolytic solution 102, and second chamber 105 may be previously filled with second electrolytic solution 104.

In single-molecule detection device 200 in accordance with Embodiment 2, micro flow channels used as first chamber 103 and second chamber 105 can reduce the time required for biomolecule 154 to reach chimeric protein 108, and it is possible to readily detect a single biomolecule.

### Exemplary Embodiment 3

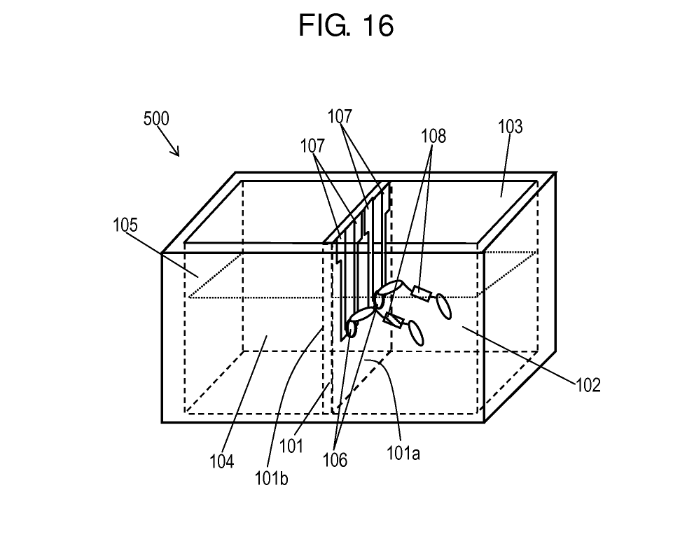

FIG. 16 is a perspective view of single-molecule detection device 500 in accordance with Exemplary Embodiment 3. In FIG. 16, components identical to those of single-molecule detection device 100 in accordance with Embodiment 1 shown in FIG. 1 are denoted by the same reference numerals.

In single-molecule detection device 500 in accordance with Embodiment 3, substrate 101 has plural through-holes 106 formed therein. Plural through-holes 106 allow a single biomolecule to be readily detected.

All through-holes 106 preferably have the same shape, but at least some of plural through-holes 106 may have different shapes. In the case that the shape of through-hole 106 viewed from the normal direction of surface 101a of substrate 101 is circular, all through-holes 106 preferably have the same diameter, but some of through-holes 106 may have different diameters.

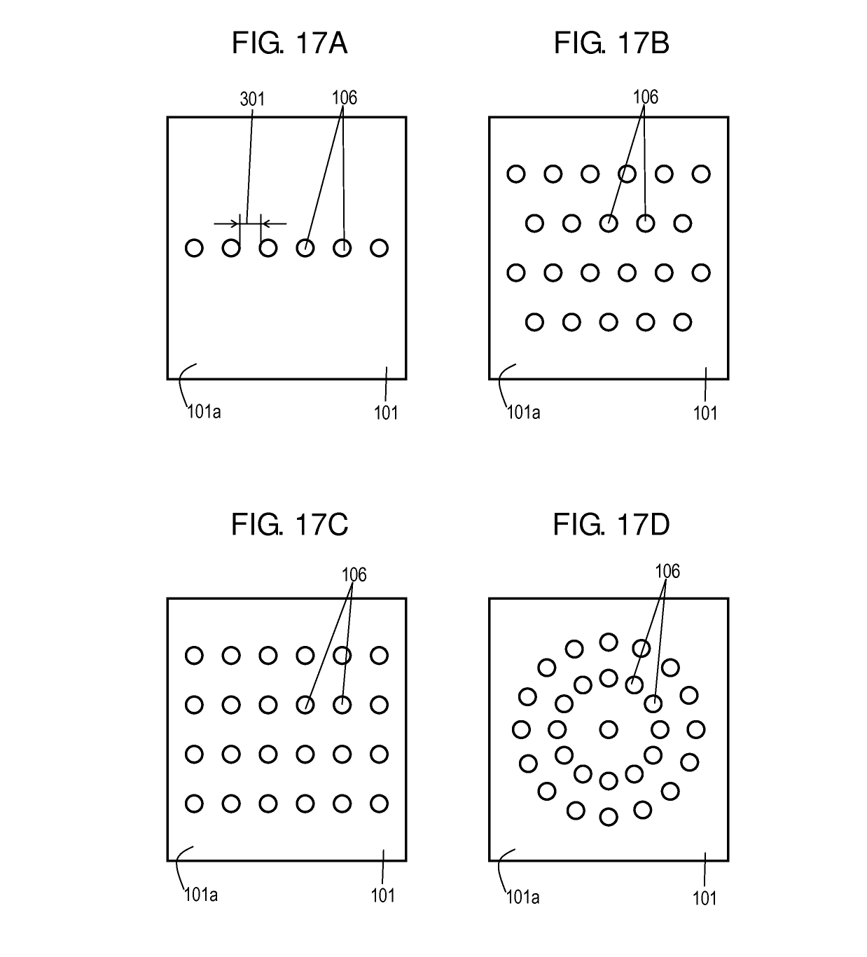

Through-holes 106 are arranged in substrate 101. FIG. 17A is a plan view of substrate 101 viewing from surface 101a of substrate 101. Plural through-holes 106 are arranged one-dimensionally on a line in surface 101a. Plural through-holes 106 may be arranged on a curve or on an arc.

FIG. 17B is a plan view of substrate 101 viewing from surface 101a of substrate 101 having another arrangement of plural through-holes 106. Through-holes 106 may be arranged two-dimensionally. For increasing the number of through-holes 106, through-holes 106 are preferably arranged in a triangle lattice, as shown in FIG. 17B, allowing through-holes 106 to be arranged densely.

FIG. 17C is a plan view of substrate 101 viewing from surface 101a of substrate 101 having still another arrangement of plural through-holes 106. As shown in FIG. 17C, through-holes 106 may be arranged in a rectangular lattice. FIG. 17D is a plan view of substrate 101 viewing from surface 101a of substrate 101 having a further arrangement of plural through-holes 106. As shown in FIG. 17D, through-holes 106 may be arranged on an arc. Through-holes 106 may be arranged on a helix, a radial line, or a closed curve.

As shown in FIG. 17A, interval 301 between through-holes 106 adjacent to each other is preferably not smaller than 1 nm and not larger than 100 nm, and more preferably, is not smaller than 10 nm and not larger than 50 nm. Interval 301 between through-holes 106 adjacent to each other is the closest distance between through-holes 106 adjacent to each other, as shown in FIG. 17A. Interval 301 between through-holes 106 adjacent to each other is preferably larger than the diameter of through-holes 106. A larger distance between adjacent through-holes 106 can reduce a noise during the detection. Interval 301 is preferably larger than the diameter of a chimeric protein. This configuration can reduce interference between chimeric proteins 108 immobilized at through-holes 106 adjacent to each other, and reduce noise at the detection. All through-holes 106 are preferably arranged at identical interval 301, but some of plural through-holes 106 may be arranged at different intervals 301.

Single-molecule detection device 500 includes plural electrode pairs 107. Each of plural electrode pairs 107 are provided at respective one of plural through-holes 106, as shown in FIG. 16. Some of plural through-holes 106 may share one electrode pair 107. Electrode pairs 107 provided at plural through-holes 106 are formed on surface 101a of substrate 101. Electrode pairs 107 provided at plural through-holes 106 are preferably formed on the same surface. Plural electrode pairs 107 may be provided in multilayer, and may be formed on plural surfaces. Electrode pair 107 is preferably covered with an insulating film.

Plural through-holes 106 are preferably with different chimeric proteins 108. Plural through-holes 106 provided with different chimeric proteins 108 can detect different kinds of biomolecules simultaneously. For this purpose, in particular, plural through-holes 106 are preferably provided with chimeric proteins 108 having different target sequences 109.

In the case that plural through-holes 106 are provided with different chimeric proteins 108, plural tunnel currents in plural through-holes 106 can be detected. The plural tunnel currents detected in plural through-holes 106 are preferably subjected to main-component analysis. The main-component analysis is conducted to the tunnel currents that are detected in plural through-holes 106, thereby identifying, quantifying, classifying, and separating a biomolecule.

Plural through-holes 106 are preferably provided with chimeric proteins 108 having same first proteins 110 and/or same second proteins 111.

Plural through-holes 106 may be provided with same chimeric protein 108. Plural through-holes 106 provided with same chimeric protein 108 increases the opportunity for the biomolecules to bind to chimeric protein 108, so that a biomolecule can be readily detected.

In the case that plural through-holes 106 are provided with same chimeric protein 108, the plural tunnel currents detected in plural through-holes 106 are preferably arithmetically averaged. Alternatively, in the case that plural through-holes 106 are provided with same chimeric protein 108, the value coincident among tunnel currents detected in at least three through-holes 106 may be determined as a true value.

The plural tunnel currents detected in plural through-holes 106 are preferably measured simultaneously. In this case, each of plural through-holes 106 is preferably provided with tunnel current detectors 181. The number of tunnel current detectors 181 is preferably the same as the number of through-holes 106, but may be smaller than the number of through-holes 106, or may be one. The plural tunnel currents detected in plural through-holes 106 may be measured with time differences. In this case, the tunnel currents detected in plural through-holes 106 are measured while tunnel current detectors 181 are switched. Measuring tunnel currents while switching tunnel current detectors 181 can reduce the number of tunnel current detectors 181, and to provide single-molecule detection device 100 with a small size.

In plural through-holes 106, an error is detected preferably by each of electrode pairs 107. This error is caused by, for example, functional defect of through-hole 106, functional defect of electrode pair 107, and contamination with air bubbles in through-hole 106, and is caused by all related matters including function, shape, operation, and process defect regarding single-molecule detection device 100. Error detection is preferably conducted in an initial stage of detecting a single molecule. The error detection is preferably conducted after process A and before process B. The error detection may be conducted after process B and before process C. Through-hole 106 for which an error is detected is preferably excluded in data acquisition.

Plural through-holes 106 in accordance with Embodiment 3 may be applied to micro flow channels of single-molecule detection device 200 in accordance with Embodiment 2.

### INDUSTRIAL APPLICABILITY

A single-molecule detection method using a single-molecule detection device according to the present invention can be utilized in the fields of environment, chemical industry, semiconductor, finance, food, house, automobile, security, life, agriculture, forestry, fishery, transportation, safety, care and welfare, for example, in a chemical substance detector, a biomolecule analyzer, an air pollutant analyzer, a water pollutant analyzer, a residual pesticide analyzer, a food composition analyzer, a narcotic analyzer, an alcohol checker, a smoking checker, a decay checker, an explosive detector, a gas leak detector, a fire alarm, a missing person searching machine, an individual identifier, an air cleaner and so on. Further, the single-molecule detection device and the single-molecule detection method according to the present invention are applicable in the fields of medicine, pharmacy, and health care, for example, in an adult disease diagnostic device, an urine analyzer, a body fluid analyzer, a blood analyzer, a blood gas analyzer, an expiration analyzer, a stress meter and so on.

### REFERENCE MARKS IN THE DRAWINGS

100 Single-Molecule Detection Device
101 Substrate
102 First Electrolytic Solution
103 First Chamber
104 Second Electrolytic Solution
105 Second Chamber
106 Through-Hole
107 Electrode Pair
107a Electrode (First Electrode)
107b Electrode (Second Electrode)
108 Chimeric Protein
109 Target Sequence
110 First Protein
111 Second Protein
151 Target Peptide Component
152a Linker Component
152b Linker Component
153 Peptide Binding Domain
154 Biomolecule
181 Tunnel Current Detector
1152b Linker Component
2152b Linker Component

1. A method of detecting a single biomolecule contained in a sample solution, said method comprising:
preparing a single-molecule detection device which includes
a substrate having a first surface and a second surface opposite to the first surface, the substrate having a through-hole penetrating the substrate from the first surface and the second surface,
an electrode pair provided around the through-hole,
a first chamber facing the first surface of the substrate, the first chamber being configured to accommodate a first electrolytic solution therein,
a second chamber facing the second surface of the substrate, the second chamber being configured to accommodate a second electrolytic solution therein, and
a chimeric protein immobilized at one end of the through-hole, the chimeric protein including a target sequence configured to have the biomolecule act thereon, a first protein provided at one end of the target sequence, and a second protein provided at another end of the target sequence, wherein the chimeric protein is immobilized at the one end of the through-hole via the first protein;
introducing the sample solution into the first chamber;
causing a change in a conformation of the chimeric protein by allowing the biomolecule to act on the target sequence; and
detecting the change in the conformation of the chimeric protein based on a tunnel current flowing to the electrode pair via the chimeric protein.

2. The method according to claim 1, wherein the first protein comprises a fluorescent protein.

3. The method according to claim 1, wherein the second protein comprises a fluorescent protein.

4. The method according to claim 1, wherein the first protein comprises GFP, CFP, YFP, REP, BFP, or variant thereof.

5. The method according to claim 1, wherein the second protein comprises GFP, CFP, YFP, REP, BFP, or variant thereof.

6. The method according to claim 1, wherein the first protein comprises CFP or variant thereof, and the second protein comprises YFP or variant thereof.

7. The method according to claim 1,
wherein the chimeric protein further includes a target peptide component and a linker component,
wherein the target sequence includes a peptide binding domain for binding with the target peptide component, and
wherein the linker component chemically binds the target sequence to the target peptide component, and the target sequence and the target peptide component bind to the first protein or the second protein.

8. The method according to claim 1, wherein said causing the change in the conformation of the chimeric protein by allowing the biomolecule to act on the target sequence comprises changing relative positions between the target peptide component and the peptide binding domain by allowing the biomolecule to act on the target sequence.

9. The method according to claim 1, wherein said causing the change in the conformation of the chimeric protein by allowing the biomolecule to act on the target sequence comprises changing relative positions between the first protein and the second protein by allowing the biomolecule to act on the target sequence.

10. The method according to claim 1, wherein said detecting the change in the conformation of the chimeric protein based on the tunnel current flowing to the electrode pair via the chimeric protein comprises detecting a change in relative positions or orientations of the first protein and the second protein with the electrode pair.

11. The method according to claim 10, wherein said detecting the change in the conformation of the chimeric protein based on the tunnel current flowing to the electrode pair via the chimeric protein comprises detecting a change in relative positions between the first protein and the second protein based on the tunnel current flowing to the electrode pair.

12. The method according to claim 1, wherein said preparing the single-molecule detection device comprises preparing the single-molecule detection device, wherein
the electrode pair includes a first electrode and a second electrode apart from each other,
the first protein of the chimeric protein is immobilized at the one end of the through-hole to allow a tunnel current to flow through the first protein and the first electrode, and
each of the first protein and the second protein of the chimeric protein is positioned to disable a tunnel current to flow between the second electrode and each of the first protein and the second protein.

13. The method according to claim 12,
wherein said causing the change in the conformation of the chimeric protein by allowing the biomolecule to act on the target sequence comprises changing the conformation of the chimeric protein by allowing the biomolecule to act on the target sequence to allow a tunnel current to flow between the second electrode and the second protein, and
wherein said detecting the change in the conformation of the chimeric protein based on the tunnel current flowing to the electrode pair via the chimeric protein comprises detecting the change in the conformation of the chimeric protein based on a tunnel current flowing between the first electrode and the second electrode via the first protein and the second protein.

14. A single-molecule detection device for detecting a single biomolecule, comprising:
a substrate having a first surface and a second surface opposite to the first surface, the substrate having a through-hole penetrating the substrate from the first surface and the second surface;
a first chamber facing the first surface of the substrate, the first chamber being configured to accommodate a first electrolytic solution therein;
a second chamber facing the second surface of the substrate, the second chamber being configured to accommodate a second electrolytic solution therein;
an electrode pair provided around the through-hole; and
a chimeric protein immobilized to one end of the through-hole,
wherein the chimeric protein includes:
a target sequence configured to allow the biomolecule to act thereon;
a first protein provided at one end of the target sequence; and
a second protein provided at another end of the target sequence, and
wherein the chimeric protein is immobilized at the one end of the through-hole via the first protein.

15. The single-molecule detection device according to claim 14, wherein a diameter of the through-hole is larger than a diameter of the chimeric protein.

16. The single-molecule detection device according to claim 14, wherein a part of the substrate is covered with SiON.

17. The single-molecule detection device according to claim 14,
wherein the electrode pair includes a first electrode and a second electrode apart from each other,
wherein the first protein of the chimeric protein is immobilized at the one end of the through-hole so as to allow a tunnel current to flow between the first protein and the first electrode, and
wherein each of the first protein and the second protein of the chimeric protein is positioned to disable a tunnel current to flow between the second electrode and each of the first protein and the second protein.

18. A single-molecule detection device for detecting a single biomolecule, comprising:
a substrate having a first surface and a second surface opposite to the first surface, the substrate having a through-hole penetrating the substrate from the first surface to the second surface;
a first chamber facing the first surface of the substrate, the first chamber being configured to accommodate a first electrolytic solution therein;
a second chamber facing the second surface of the substrate, the second chamber configured to accommodate a second electrolytic solution therein;
an electrode pair provided around the through-hole, and a chimeric protein configured to be immobilized at one end of the through-hole,
wherein the chimeric protein includes:
a target sequence configured to allow the biomolecule to act thereon;
a first protein provided at one end of the target sequence; and
a second protein provided at another end of the target sequence, and
wherein the chimeric protein is configured to be immobilized at the one end of the through-hole via the first protein.

19. A disease marker test device for executing the method according to claim 1.
